(19) United States
(12) Patent Application Publication
(10) Pub. No.: US 2008/0174746 A1
(43) Pub. Date: Jul. 24, 2008

(54) METHOD FOR PROJECTING AN IMAGE FROM ONE OF A PLURALITY OF HOSTS AND PROJECTION DEVICE THEREOF

(76) Inventors: Wei-Ting Lai, Taipei County (TW); Chang-Hung Lee, Yun-Lin Hsien (TW); Chih-Wei Yang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/626,335

(22) Filed: Jan. 23, 2007

(51) Int. Cl. G03B 21/14

(52) U.S. Cl. 353/121; 353/122

(57) ABSTRACT

A method for projecting an image transmitting from one of a plurality of hosts by a projection device is disclosed. The method includes: (a) the plurality of hosts each logging into the projection device using wireless communication technology; (b) selecting a first host among the plurality of hosts connected to the projection device; (c) the projection device allowing the selected first host to transmit data to the projection device using wireless communication technology; and (d) the projection device projecting an image corresponding to the data transmitted from the first host.

### BACKGROUND OF THE INVENTION

1. Field of the Invention

The present invention relates to a method for projecting an image from one of a plurality of hosts using a projection device selectively and the projection device thereof, and more particularly, to a method for projecting an image from one of a plurality of hosts connected to a projection device in a wireless communication method using the projection device selectively and the projection device thereof.

2. Description of the Prior Art

The operation theory of projectors is similar to that of devices for displaying slides or transparencies; i.e. in both of the above-mentioned devices a high brightness/luminance light bulb is utilized as a light source, and the content to be displayed is projected on a white display curtain or a wall. In addition, because a projector provides several different image transmission interfaces, the projector can receive data transmitted by digital or analogue image sources, such as a computer or a television, and project the transmitted images on a white display curtain or a wall, enlarging the image scale and therefore enabling many people to see them. For this reason, projectors are usually utilized in large-scale meetings in which a host projects data or graphics onto a screen for familiarizing attendants with a presentation. Modern projectors have become portable, and both size and price have been reduced, therefore giving them great potential in the current market.

However projectors in the current market are generally only capable of receiving images from a single host. That is to say, the user needs to connect the projector with the host which is an image source in a one to one connection, such as D-SUB connection, or in a wireless communication method, and needs to disconnect the projector from the remaining hosts, such as removing cables connected to the projector and the remaining hosts or the remaining hosts being off-line from the projector. It is inconvenient to switch the different hosts for projecting images by the projector conventionally.

### SUMMARY OF THE INVENTION

It is therefore a primary objective of the claimed invention to provide a method for selectively projecting an image from one of a plurality of hosts using a projection device and the projection device thereof for solving the above-mentioned problem.

According to the claimed invention, a method for selectively projecting an image transmitted from one of a plurality of hosts by a projection device is disclosed. The method includes: (a) the plurality of hosts each logging into the projection device using wireless communication technology; (b) selecting a first host among the plurality of hosts connected to the projection device; (c) the projection device allowing the selected first host to transmit data to the projection device using wireless communication technology; and (d) the projection device projecting an image corresponding to the data transmitted from the first host.

According to the claimed invention, a projection device capable of selectively projecting an image transmitted from one of a plurality of hosts is disclosed. The projection device includes a wireless communication module for receiving data transmitted from the plurality of hosts using wireless communication technology, a selecting means for selecting a first host among the plurality of hosts connected to the projection device, a projection module for projecting images, and a control means for allowing the first host to transmit data to the wireless communication module by wireless communication technology and for controlling the projection module to project an image corresponding to the data transmitted from the first host.

According to the claimed invention, a projection system capable of selectively projecting an image transmitted from one of a plurality of hosts is disclosed. The projection system includes a plurality of hosts, and a projection device connected to the plurality of hosts in a wireless communication method. The projection device includes a wireless communication module for receiving data transmitted from the plurality of hosts using wireless communication technology, a selecting means for selecting a first host among the plurality of hosts connected to the projection device, a projection module for projecting images, and a control means for allowing the first host to transmit data to the wireless communication module by wireless communication technology and for controlling the projection module to project an image corresponding to the data transmitted from the first host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a projection system capable of projecting an image transmitted from a plurality of hosts selectively according to a preferred embodiment of the present invention.

FIG. 2 is a flowchart of a projection device projecting an image transmitted from a host selected by a selecting mean according to the preferred embodiment of the present invention.

FIG. 3 is a diagram of a client table according to the preferred embodiment of the present invention.

### DETAILED DESCRIPTION

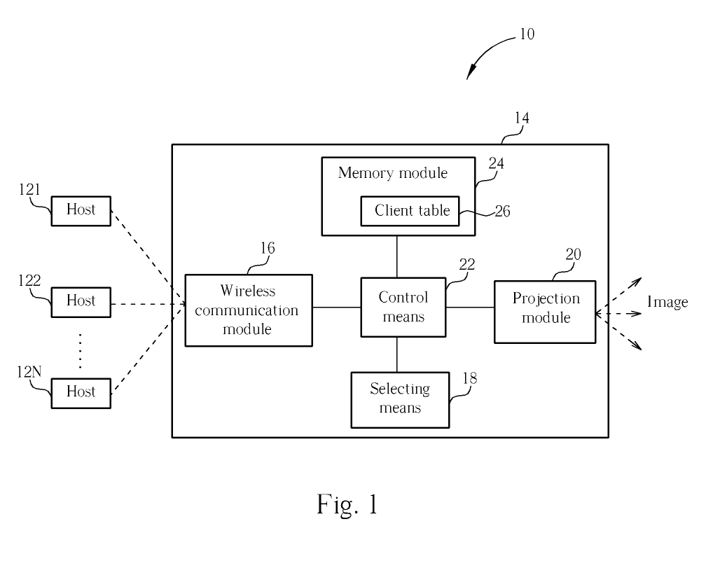

Please refer to FIG. 1. FIG. 1 is a functional block diagram of a projection system 10 capable of selectively projecting an image transmitted from one of a plurality of hosts 121-12N according to a preferred embodiment of the present invention. The projection system 10 includes the plurality of hosts 121-12N which can be a computer, and a projection device 14 connected to the plurality of hosts 121-12N in a wireless communication method. The projection device 14 includes a wireless communication module 16 for receiving data transmitted from the plurality of hosts 121-12N using wireless communication technology, and a selecting means 18 for selecting a host among the plurality of hosts 121-12N connected to the projection device 14. The selecting means 18 can be in the form of a logic circuit, software, hardware, and so on. For example, the selecting means 18 can be a remote controller for selecting the host using remote control technology, such as infrared technology or wireless network technology (802.11). The selecting means 18 also can be an OSD interface so that the user can select or switch the host among the plurality of hosts 121-12N with the OSD interface. The projection device 14 further includes a projection module 20 for projecting images, and a control means 22 for allowing the host selected by the selecting means 18 to transmit data to the wireless communication module 16 of the projection device 14 using wireless communication technology and for controlling the projection module 20 to project an image corresponding to the data transmitted from the host selected by the selecting means 18. The control means 22 can be in the form of a logic circuit, software, hardware, and so on. For example, the control means 22 can be a processor, a control unit, or an application program. The projection device 14 further includes a memory module 24 for storing a client table 26 which contains information of each of the plurality of hosts 121-12N.

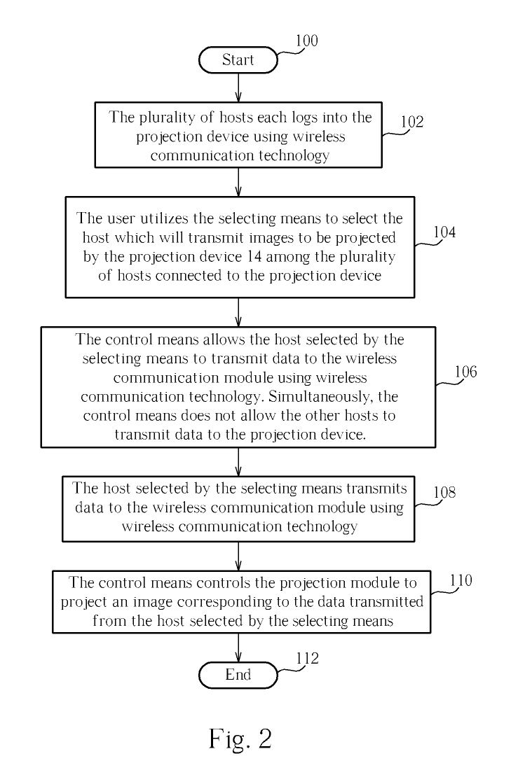

Please refer to FIG. 2. FIG. 2 is a flowchart of the projection device 14 projecting an image transmitted from the host selected by the selecting mean 18 according to the preferred embodiment of the present invention. The method includes following steps:

Step 100: Start.

Step 102: The plurality of hosts 121-12N each logs into the projection device 14 using wireless communication technology.

Step 104: The user utilizes the selecting means 18 to select the host which will transmit images to be projected by the projection device 14 among the plurality of hosts 121-12N connected to the projection device 14.

Step 1106: The control means 22 of the projection device 14 allows the host selected by the selecting means 18 to transmit data to the wireless communication module 16 of the projection device 14 using wireless communication technology. Simultaneously, the control means 22 does not allow the other hosts to transmit data to the projection device 14.

Step 108: The host selected by the selecting means 18 transmits data to the wireless communication module 16 of the projection device 14 using wireless communication technology.

Step 110: The control means 22 controls the projection module 20 to project an image corresponding to the data transmitted from the host selected by the selecting means 18.

Step 112: End.

More detailed descriptions for the steps mentioned above will be provided. First the plurality of hosts 121-12N each logs into the projection device 14 using wireless communication technology so as to have allowance of projecting images. For example, the plurality of hosts 121-12N each sends probe requests to the projection device 14 using wireless communication technology, and then the projection device 14 sends back a probe response to each of the plurality of hosts 121-12N. Subsequently the plurality of hosts 121-12N each sends authentication requests to the projection device 14 using wireless communication technology, and then the projection device 14 sends back an authentication response to each of the plurality of hosts 121-12N. For instance, each of the plurality of hosts 121-12N can log into the projection device 14 with its own identification and password using wireless communication technology for the authentication requests. The projection device 14 adds the identification of each of the plurality of hosts 121-12N to a client table and stores the client table in the memory module 24. Subsequently the plurality of hosts 121-12N each sends association requests to the projection device 14 using wireless communication technology, and then the projection device 14 sends back an association response to each of the plurality of hosts 121-12N. The projection device 14 can name each of the plurality of hosts 121-12N as its own identification or account for distinguishing the plurality of hosts 121-12N. Subsequently each of the plurality of hosts 121-12N broadcasts its own IP address to the projection device 14 using wireless communication technology, and then the projection device 14 adds the IP address of each of the plurality of hosts 121-12N to the client table.

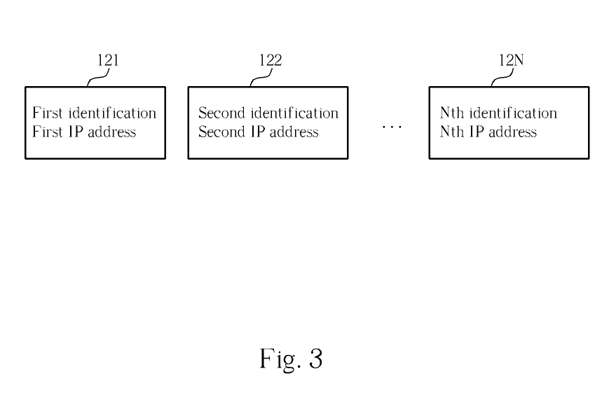

Afterward the user can utilize the selecting means 18 to select the host which will transmit images to be projected by the projection device 14 next among the plurality of hosts 121-12N connected to the projection device 14. Please refer to FIG. 3. FIG. 3 is a diagram of the client table according to the preferred embodiment of the present invention. The client table includes information of identification (name/account) and an IP address of each of the plurality of hosts 121-12N. The projection device 14 can project the client table on a screen, and the user can utilize the selecting means 18 to select the host as an OSD interface. The selecting means can be a plurality of buttons and the user presses the buttons to switch the plurality of hosts 121-12N for selecting the host. The selecting means also can be a remote controller for selecting the host using remote control technology, such as infrared technology or wireless network technology (802.11). In addition, the projection device 14 also can display the client table on a display module (not shown in figures) of the projection device 14 for providing the user to select the host by the selecting means 18. After the user utilizes the selecting means 18 to select the host, the selecting means 18 outputs a corresponding signal to the control means 22. The control means 22 will choose the host selected by the selecting means 18 to transmit data between the host and the projection device 14 uniquely. That is to say, the control means 22 allows the host selected by the selecting means 18 to transmit data to the wireless communication module 16 of the projection device 14 using wireless communication technology. Simultaneously, the control means 22 does not allow the other hosts to transmit data to the projection device 14. The plurality of hosts 121-12N still keeps the wireless communication with the projection device 14, but only the host selected by the selecting means 18 can transmit data to the wireless communication module 16 of the projection device 14 using wireless communication technology. During the period of transmitting data between the host selected by the selecting means 18 and the projection device 14, the plurality of hosts 121-12N excluding the host selected by the selecting means 18 can log in or log out from the projection device 14 independently. At last, the control means 22 controls the projection module 20 to project an image corresponding to the data transmitted from the host selected by the selecting means 18. When the host selected by the selecting means 18 finishes a projection job, the user can utilize the selecting means 18 to select the host which will transmit images to be projected by the projection device 14 next among the plurality of hosts 121-12N. The initial host selected by the selecting means 18 does not need to log out from the projection device 14, and the other host selected by the selecting means 18 next can transmit data to the projection device 14 continuously. It means the user does not have to wait for the logout of the first host and the login of the next host. The present invention can economize time of switching the plurality of hosts 121-12N to project images.

In contrast to the prior art, the present invention can provide the user to select the host among the plurality of hosts for projecting images by the projection device while the plurality of hosts still keeps the wireless communication with the projection device. The user does not have to wait for the logout of the first host and the login of the next host. The present invention can economize time of switching the plurality of hosts to project images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for selectively projecting an image transmitted from one of a plurality of hosts by a projection device, the method comprising:
(a) the plurality of hosts each logging into the projection device using wireless communication technology;
(b) selecting a first host among the plurality of hosts connected to the projection device;
(c) the projection device allowing the selected first host to transmit data to the projection device using wireless communication technology; and
(d) the projection device projecting an image corresponding to the data transmitted from the first host.

2. The method of claim 1 wherein step (a) comprises the plurality of hosts sending probe requests to the projection device using wireless communication technology respectively, and the projection device sending a probe response to each of the plurality of hosts.

3. The method of claim 1 wherein step (a) comprises the plurality of hosts sending authentication requests to the projection device using wireless communication technology respectively, and the projection device sending an authentication response to each of the plurality of hosts.

4. The method of claim 1 wherein step (a) comprises the plurality of hosts sending association requests to the projection device using wireless communication technology respectively, and the projection device sending an association response to each of the plurality of hosts.

5. The method of claim 1 wherein step (a) comprises each of the plurality of hosts logging into the projection device with its own identification and password using wireless communication technology.

6. The method of claim 5 further comprising the projection device adding the identification of each of the plurality of hosts to a client table and displaying the client table.

7. The method of claim 6 wherein step (b) comprises selecting the first host among the plurality of hosts connected to the projection device according to the client table.

8. The method of claim 1 wherein step (a) comprises each of the plurality of hosts broadcasting its own IP address to the projection device using wireless communication technology.

9. The method of claim 8 further comprising the projection device adding the IP address of each of the plurality of hosts to a client table and displaying the client table.

10. The method of claim 9 wherein step (b) comprises selecting the first host among the plurality of hosts connected to the projection device according to the client table.

11. The method of claim 1 wherein step (b) comprises selecting the first host among the plurality of hosts connected to the projection device using remote control technology.

12. The method of claim 11 wherein step (b) further comprises selecting the first host among the plurality of hosts connected to the projection device using infrared technology.

13. The method of claim 11 wherein step (b) comprises selecting the first host among the plurality of hosts connected to the projection device using wireless network technology.

14. The method of claim 1 wherein step (b) comprises utilizing an OSD interface of the projection device to select the first host among the plurality of hosts connected to the projection device.

15. The method of claim 1 wherein step (c) comprises the control means not allowing the other hosts to transmit data to the projection device.

16. A projection device capable of selectively projecting an image transmitted from one of a plurality of hosts, the projection device comprising:
a wireless communication module for receiving data transmitted from the plurality of hosts using wireless communication technology;
a selecting means for selecting a first host among the plurality of hosts connected to the projection device;
a projection module for projecting images; and
a control means for allowing the first host to transmit data to the wireless communication module by wireless communication technology and for controlling the projection module to project an image corresponding to the data transmitted from the first host.

17. The projection device of claim 16 further comprising a memory module for storing a client table comprising identification of each of the plurality of hosts.

18. The projection device of claim 16 further comprising a memory module for storing a client table comprising an IP address of each of the plurality of hosts.

19. A projection system capable of selectively projecting an image transmitted from one of a plurality of hosts, the projection system comprising:
a plurality of hosts; and
a projection device connected to the plurality of hosts in a wireless communication method, the projection device comprising:
a wireless communication module for receiving data transmitted from the plurality of hosts using wireless communication technology;
a selecting means for selecting a first host among the plurality of hosts connected to the projection device;
a projection module for projecting images; and
a control means for allowing the first host to transmit data to the wireless communication module by wireless communication technology and for controlling the projection module to project an image corresponding to the data transmitted from the first host.

20. The projection system of claim 19 wherein the projection device further comprises a memory module for storing a client table comprising identification of each of the plurality of hosts.

21. The projection system of claim 19 wherein the projection device further comprises a memory module for storing a client table comprising an IP address of each of the plurality of hosts.
